(19) United States
(12) Patent Application Publication
(10) Pub. No.: US 2019/0390114 A1
(43) Pub. Date: Dec. 26, 2019

(54) LIQUID CRYSTAL COMPOSITION AND USE THEREOF

(71) Applicants: DAILY-XIANHUA OPTOELECTRONICS MATERIALS CO., LTD., Kaohsiung City (TW); Yantai Xianhua Chem-Tech Co., Ltd., Yantai (CN)

(72) Inventors: Ziqian Shi, Yantai (CN); Tsung-Yu Tsai, Kaohsiung City (TW); Shu-Ling Lo, Kaohsiung City (TW); Ming-Chuan Yang, Kaohsiung City (TW); Hanlei Shan, Yantai (CN); Peichuan Feng, Yantai (CN); Zhaochang Luan, Yantai (CN)

(73) Assignees: DAILY-XIANHUA OPTOELECTRONICS MATERIALS CO., LTD., Kaohsiung City (TW); Yantai Xianhua Chem-Tech Co., Ltd., Yantai (CN)

(21) Appl. No.: 16/356,921

(22) Filed: Mar. 18, 2019

(30) Foreign Application Priority Data
Jun. 22, 2018 (CN) 201810648307.0

(51) Int. Cl. C09K 19/44; C09K 19/12; C09K 19/20; C09K 19/30; C09K 19/34

(52) U.S. Cl. CPC C09K 19/44; C09K 2019/3422; C09K 19/20; C09K 19/3066; C09K 19/3003; C09K 19/3402; C09K 2019/122; C09K 2019/123; C09K 2019/124; C09K 2019/3004; C09K 2019/3009; C09K 2019/3025; C09K 2019/301; C09K 2019/3016; C09K 2019/3021; C09K 2019/3019; C09K 19/12

(57) ABSTRACT

A liquid crystal composition includes at least one polar compound represented by Formula (I), at least one polar compound represented by Formula (II), at least one compound represented by Formula (III), and at least one compound represented by Formula (IV), in which Formulae (I) to (IV) are as defined herein.

### CROSS-REFERENCE TO RELATED APPLICATION

This application claims priority of Chinese Patent Application No. 201810648307.0, filed on Jun. 22, 2018.

### FIELD

The disclosure relates to a liquid crystal composition, and more particularly to a liquid crystal composition including a combination of specific compounds. The disclosure also relates to use of the liquid crystal composition in the field of liquid crystal display.

### BACKGROUND

Liquid crystal display has been widely used in calculators, computer screens, televisions, and the like. Liquid crystal molecules rotate in certain degrees (for example, 90°) and may be transformed between a disordered state and an ordered state according to variation of electric field strength so as to change light transmittance. This allows the brightness of the pixels of an image to be controlled so as to produce the desired image.

Liquid crystal displays can be typically classified into thin film transistor liquid crystal display (TFT-LCD), cholesteric-nematic phase change liquid crystal display (CHN-LCD), super-twisted nematic liquid crstal display (STN-LCD), guest-host liquid crystal display (GH-LCD), twisted nematic liquid crystal display (TN-LCD), polymer dispersed liquid crystal display (PD-LCD), and ferroelectric liquid crystal display (FLCD). The TN-LCD only displays black and white color. The STN-LCD primarily displays orange yellow and light green colors, and an RGB color filter is usually added to display a color image via a combination of red, green, and blue light in a specific ratio. The TFT-LCD is provided with a thin film transistor at a back thereof to control independent pixels on a screen such that smoothness and contrast ratio of an image can be significantly enhanced. In addition, the TFT-LCD has characteristics of a relatively high voltage holding ratio, a low refractive index, a low viscosity, and the like, and displays a clear image even under a relatively strong light condition (usually called a “true color display”) and thus, the TFT-LCD is a common display in the market.

There are various display modes in the market, and among the competitive ones include in-plane switching (IPS) mode LCD, fringe-field switching (FFS) mode LCD, and vertical alignment (VA) mode LCD. The IPS mode LCD and the FFS mode LCD have characteristic of wide viewing angle. When positive liquid crystal is used in the IPS mode LCD and the FFS mode LCD, a fast response speed and good reliability can be achieved. On the other hand, when negative liquid crystal is used in the IPS mode LCD and the FFS mode LCD, a relatively high transmittance can be obtained. However, since the negative liquid crystal has a relatively larger viscosity, the response speed is relatively slow accordingly.

Both the IPS and FFS mode LCD have wide viewing angles, and the light transmittance difference between the positive liquid crystal and the negative liquid crystal is expressed primarily by the light transmittance efficiency of the liquid crystal at a spacing center of pixel electrodes. Since elastic force for rotating the positive liquid crystal is weaker than that for rotating the negative liquid crystal at the spacing center of pixel electrodes, the value of And for the positive liquid crystal should be larger than that for the negative liquid crystal. If it is desirable to obtain the same light utilization efficiency for the positive liquid crystal and the negative liquid crystal, the conventional solution therefor is to add the negative liquid crystal into the positive liquid crystal so as to enhance the light transmittance. The synthesis and the treatment for the negative liquid crystal are different from those for the positive liquid crystal. For example, the voltage holding ratio and the resistivity of the negative liquid crystal is usually reduced significantly after ultraviolet irradiation. In other words, the negative liquid crystal has inferior ultraviolet stability as compared to the positive liquid crystal. In addition, the negative liquid crystal has a relatively larger rotational viscosity as compared to the positive liquid crystal, and thus the response time cannot be effectively reduced.

### SUMMARY

Therefore, a first object of the disclosure is to provide a liquid crystal composition which can overcome the shortcomings described above by introducing negative polar groups into the molecular structure of positive liquid crystal so as to enhance light transmittance, response time, and ultraviolet stability, and to improve contrast ratio of a liquid crystal display produced therefrom.

A second object of the disclosure is to provide a liquid crystal display including the liquid crystal composition.

According to a first aspect of the disclosure, there is provided a liquid crystal composition, which comprises:

at least one polar compound represented by Formula (I),

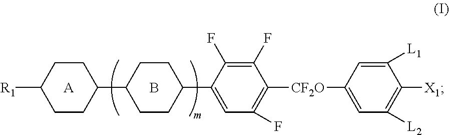

at least one polar compound represented by Formula (II),

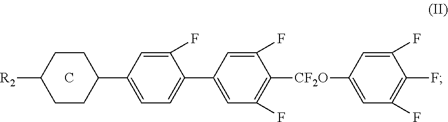

at least one compound represented by Formula (III),

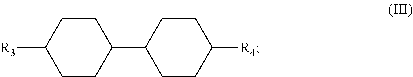

and

at least one compound represented by Formula (IV),

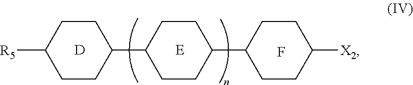

wherein

R₁, R₂, R₃, R₄, and R₅ are each independently selected from the group consisting of hydrogen, an alkyl group having 1 to 7 carbon atoms, an alkoxy group having 1 to 6 carbon atoms, an alkenyl group having 2 to 7 carbon atoms, and an alkenoxy group having 3 to 5 carbon atoms, wherein each of said alkyl group, said alkoxy group, said alkenyl group, and said alkenoxy group is unsubstituted or substituted with fluorine;

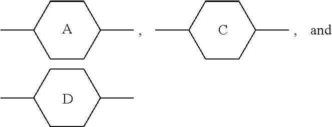

each independently represent a member selected from the group consisting of

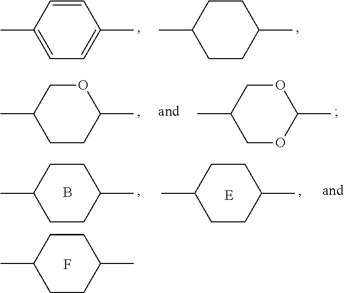

each independently represent at least one member selected from the group consisting of

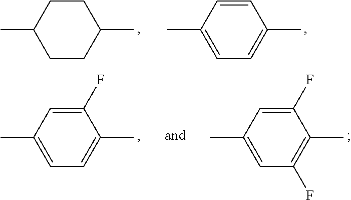

L₁ and L₂ are each independently selected from the group consisting of hydrogen and fluorine;

X₁ and X₂ are each independently selected from the group consisting of fluorine, chlorine, an alkyl group having 1 to 6 carbon atoms, a haloalkyl group having 1 to 6 carbon atoms, an alkenyl group having 2 to 6 carbon atoms, a haloalkenyl group having 2 to 6 carbon atoms, a haloalkoxy group having 1 to 6 carbon atoms, and a haloalkenoxy group having 2 to 6 carbon atoms;

m represents 0 or 1; and

n represents 0, 1, or 2,

with the proviso that when m represents 2, two of

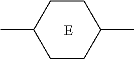

may be the same or different, and when n represents 0,

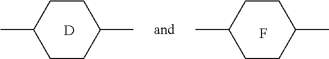

are not

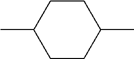

at the same time.

According to a second aspect of the disclosure, there is provided a liquid crystal display, which comprises the liquid crystal composition of the first aspect of the disclosure.

The liquid crystal composition of the disclosure is prepared via specific combination of at least one polar compound of Formula (I), at least one polar compound of Formula (II), at least one compound of Formula (III), and at least one compound of Formula (IV). In addition, some of the compounds included in the liquid crystal composition are modified by introducing at least one functional group into the molecular structures thereof (for example, in the polar compound of Formula (I), by introducing a fluoro group at a meta position on a phenylene group relative to —CF₂O), so that the dielectric anisotropy in a direction transverse to a molecular axis is increased and the light transmittance is enhanced. Therefore, a contrast ratio of a liquid crystal display containing the liquid crystal composition can be enhanced significantly. It is confirmed after measurements that the liquid crystal composition of the disclosure has high clear point, proper birefringence anisotropy, high dielectric anisotropy, low rotational viscosity, and fast response speed so as to permit the liquid crystal composition of the disclosure to be useful for active matrix LCDs, such as IPS-TFT and FFS-TFT mode.

### DETAILED DESCRIPTION

A liquid crystal composition according to the disclosure comprises:

at least one polar compound represented by Formula (I),

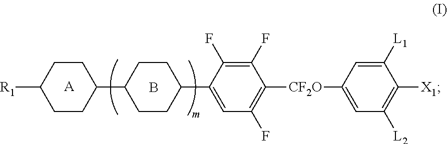

at least one polar compound represented by Formula (II),

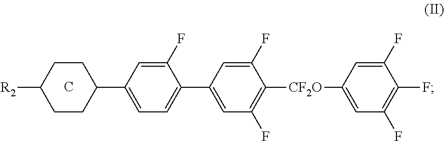

at least one compound represented by Formula (III),

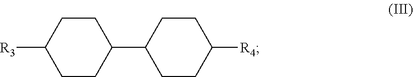

and

at least one compound represented by Formula (IV),

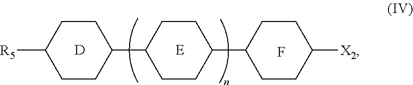

wherein

R₁, R₂, R₃, R₄, and R₅ are each independently selected from the group consisting of hydrogen, an alkyl group having 1 to 7 carbon atoms, an alkoxy group having 1 to 6 carbon atoms, an alkenyl group having 2 to 7 carbon atoms, and an alkenoxy group having 3 to 5 carbon atoms, wherein each of said alkyl group, said alkoxy group, said alkenyl group, and said alkenoxy group is unsubstituted or substituted with fluorine;

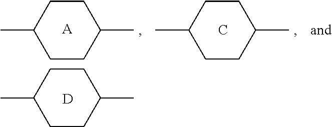

each independently represent a member selected from the group consisting

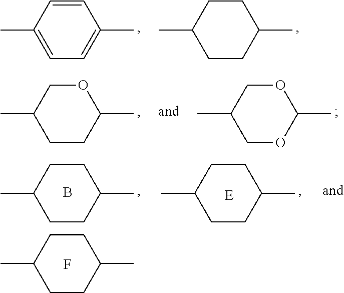

each independently represent at least one member selected from the group consisting of

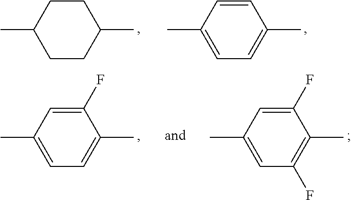

L₁ and L₂ are each independently selected from the group consisting of hydrogen and fluorine;

X₁ and X₂ are each independently selected from the group consisting of fluorine, chlorine, an alkyl group having 1 to 6 carbon atoms, a haloalkyl group having 1 to 6 carbon atoms, an alkenyl group having 2 to 6 carbon atoms, a haloalkenyl group having 2 to 6 carbon atoms, a haloalkoxy group having 1 to 6 carbon atoms, and a haloalkenoxy group having 2 to 6 carbon atoms;

m represents 0 or 1; and

n represents 0, 1, or 2,

with the proviso that when m represents 2, two of

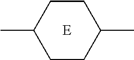

may be the same or different, and when n represents 0,

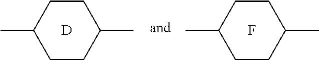

are not

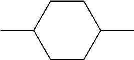

at the same time.

In certain embodiments, the polar compound represented by Formula (I) is selected from the group consisting of compounds of Formulae (I-1) to (I-13),

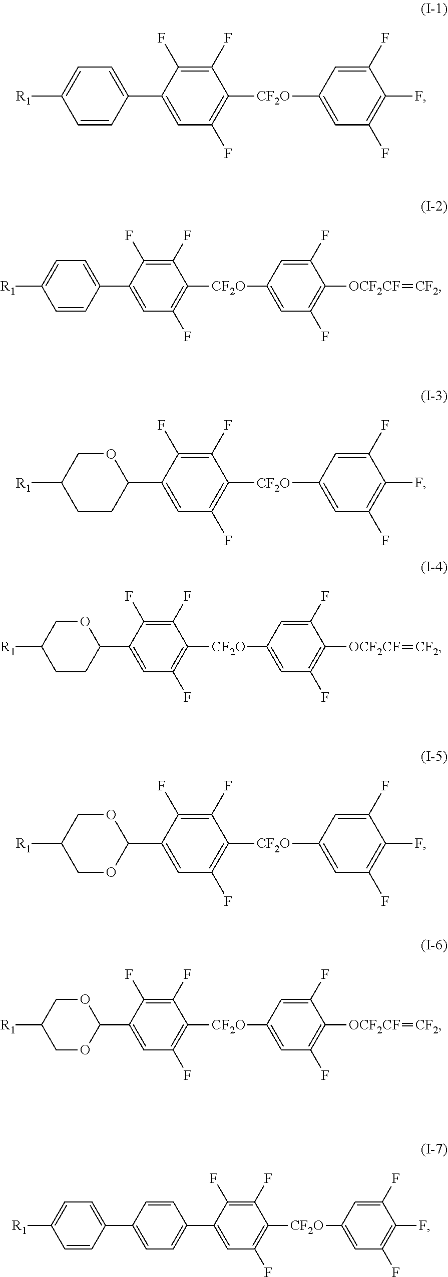

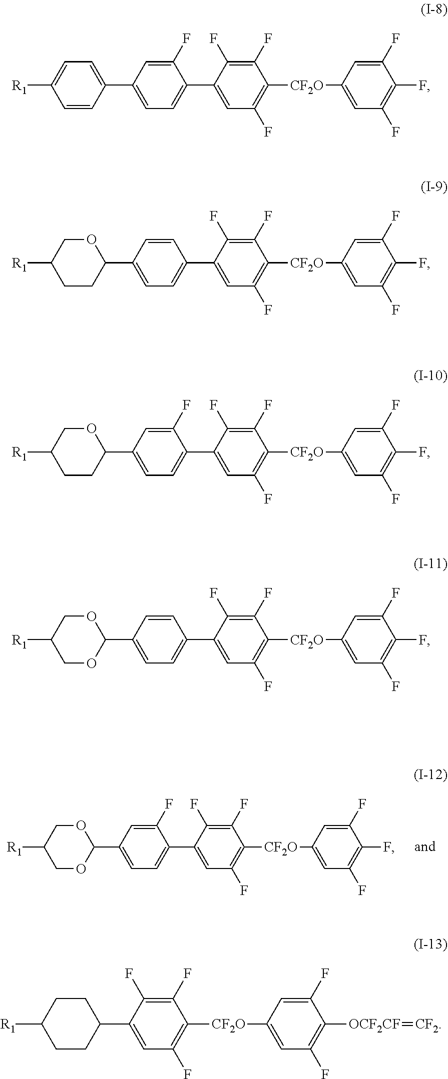

In certain embodiments, the polar compound represented by Formula (II) is selected from the group consisting of compounds of Formulae (II-1) to (II-3),

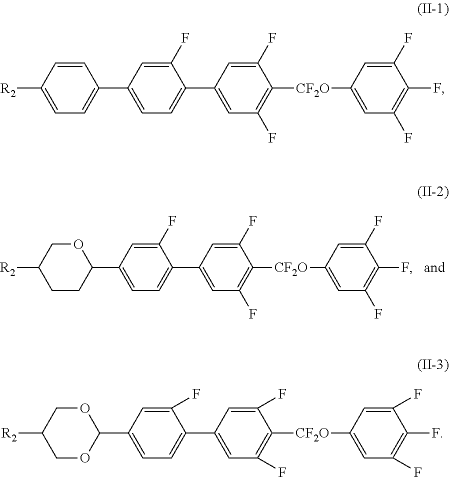

In certain embodiments, the compound represented by Formula (III) is selected from the group consisting of compounds of Formulae (III-1) and (III-2),

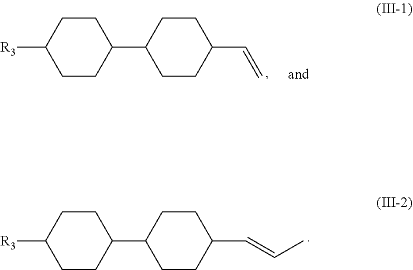

In certain embodiments, the compound represented by Formula (IV) is selected from the group consisting of compounds of Formulae (IV-1) to (IV-21),

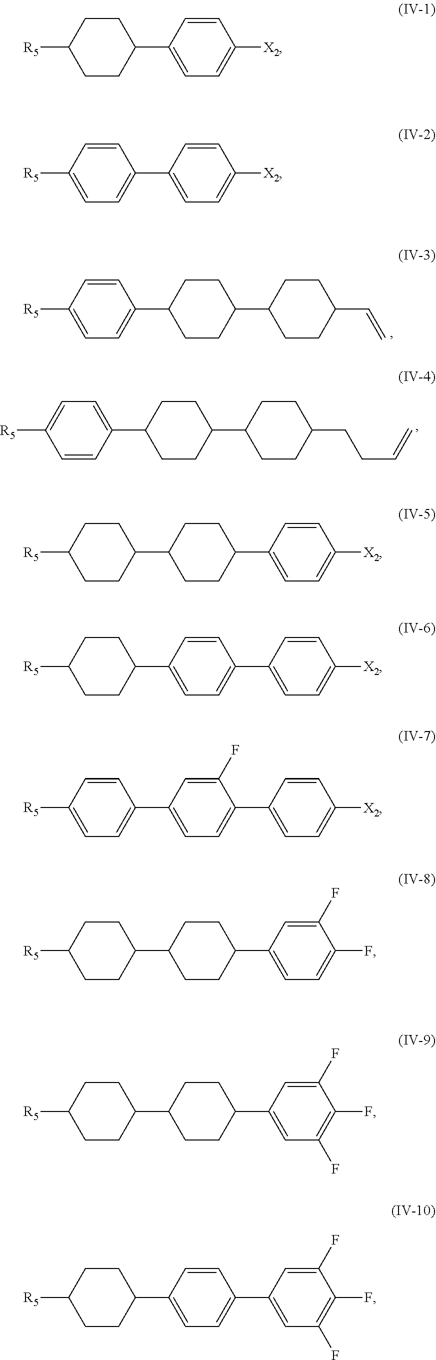

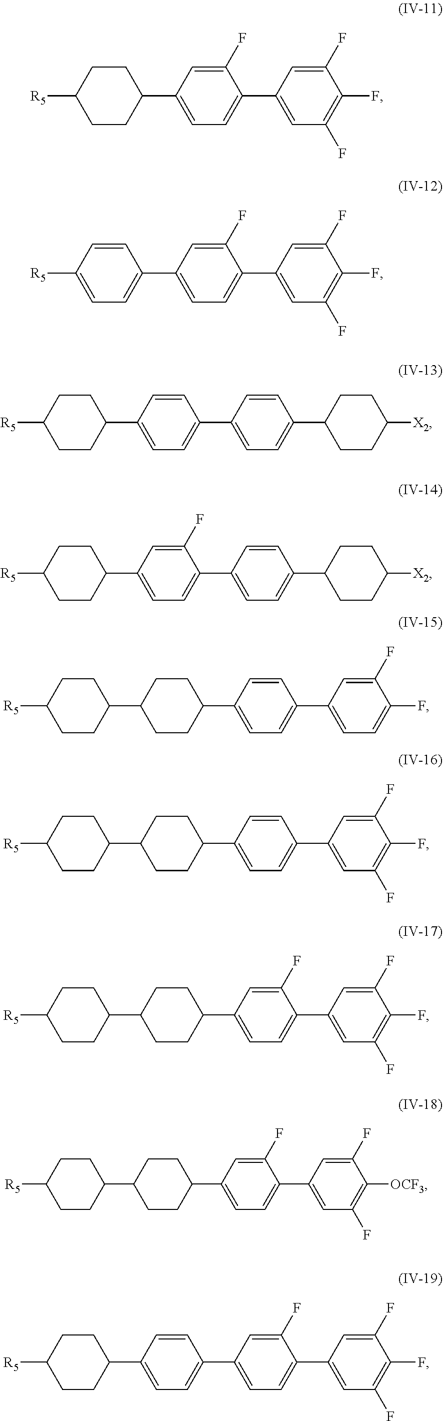

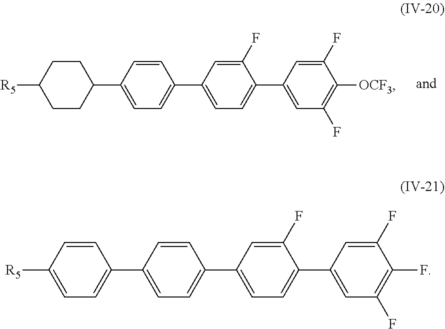

In certain embodiments, the polar compound represented by Formula (I) is in an amount ranging from 1 wt % to 20 wt %, the polar compound represented by Formula (II) is in an amount ranging from 1 wt % to 30 wt %, the compound represented by Formula (III) is in an amount ranging from 1 wt % to 70 wt %, and the compound represented by Formula (IV) is in an amount ranging from 1 wt % to 60 wt % based on 100 wt % of said liquid crystal composition.

A liquid crystal display according to the disclosure comprises the liquid crystal composition described above. When the liquid crystal composition according the disclosure is used in the IPS-TFT or FFS-TFT mode liquid crystal display, it is not necessary to further add a chiral material into the liquid crystal composition. When the liquid crystal composition according the disclosure is used in the TN-TFT mode or passive matrix mode liquid crystal display, it is necessary to further add into the liquid crystal composition, the chiral material in an amount of up to 1 wt % based on a total weight of the compounds of Formulae I to IV. In certain embodiments, additives such as ultraviolet stabilizers, dopants, and anti-oxidants can be added according to specific requirements.

Examples of the disclosure will be described hereinafter. It is to be understood that these examples are exemplary and explanatory and should not be construed as a limitation to the disclosure.

The liquid crystal composition according to the disclosure can be prepared by any methods well known in the art. For example, the compounds for preparing the liquid crystal composition are mixed and dissolved in an organic solvent at an elevated temperature to form a mixture, followed by removing the solvent from the mixture via distillation under reduced pressure, so as to obtain the liquid crystal composition. Alternatively, the compound(s) having relatively low amount(s) is (are) molten in the remaining compound(s) having relatively high amount(s) at a relatively elevated temperature to prepare the liquid crystal composition. Alternatively, each of the compounds for preparing the liquid crystal composition is separately dissolved in an organic solvent (for example, acetone, chloroform, methanol, or the like), followed by mixing together in a solvent to obtain a mixture and then removing the solvent from the mixture to obtain the liquid crystal composition.

In the specification, the percentage is given by weight percentage, the temperature is given by degree Celsius, and the symbols and the measurement conditions for various properties are described below if not stated otherwise.

### 1. Clear Point (Cp, ° C.):

A liquid crystal composition was observed using a microscope while being heated using a heater. The temperature at which the liquid crystal composition transformed from a liquid crystal phase to a liquid phase was recorded as a clear point of the liquid crystal composition.

### 2. Melting Temperature (S—N, ° C.):

A liquid crystal composition was filled into a liquid crystal box, followed by placement of the liquid crystal box in a freezer at a temperature of −30° C. or −40° C. and observation of the crystalline state of the liquid crystal composition. The temperature at which the liquid crystal composition transformed from the crystalline state to a nematic phase was recorded as a melting point of the liquid crystal composition.

### 3. Optical Anisotropy (Δn):

Measurement was implemented at a wavelength of 589 nm and at a temperature of 25° C. using an Abbe refractometer (Manufacturer: ATAGO Co. Ltd., Japan). The optical anisotropy was calculated according to a formula as below.

Δn=ne−no,

wherein

ne is an refractive index of extraordinary light; and

no is an refractive index of ordinary light.

In order to meet the requirements for subsequent applications, the optical anisotropy (i.e., Δn) of the liquid crystal composition is preferably in a range from 0.065 to 0.200.

### 4. Dielectric Anisotropy (Δε):

A liquid crystal composition sample was placed in a 25 μm PAN cell in which no chiral dopant was added. Measurement was implemented at a temperature of 25° C. using a measurement instrument (Manufacturer: INSTEC; Model: ALCT-IR1). The dielectric anisotropy was calculated according to a formula as below.

Δε=ε∥−ε⊥,

wherein

ε∥ is a dielectric constant parallel to a molecular axis; and

ε⊥ is a dielectric constant transverse to a molecular axis.

In order to meet the requirements for subsequent applications, the dielectric anisotropy (i.e., Δε) of the liquid crystal composition is preferably in a range from 2 to 11.

5. Rotational Viscosity (γ1, mPa·s):

A liquid crystal composition sample was placed in a 25 μm PAN cell in which no chiral dopant was added. Measurement was implemented at a temperature of 25±0.2° C. using a measurement instrument (Manufacturer: INSTEC; Model: ALCT-IR1). The lower the rotational viscosity, the faster the response speed with the shorter the response time. In order to meet the requirements for subsequent applications, the rotational viscosity (i.e., γ1) of the liquid crystal composition is preferably in a range from 25 mPa·s to 110 mPa·s.

The liquid crystal compositions in the following examples were prepared by a heat-dissolution process or a vibration-mixing process well known in the art. Specifically, the compounds for preparing each of the liquid crystal compositions were weighed in weight percentages, and were added into a container in unspecified order, preferably in an order in which the compound having a relatively high melting point was added before the compound having a relatively low melting point, followed by stirring or vibrating at a constant temperature of 60° C. to obtain a homogeneous mixture. The homogeneous mixture was treated via absorption, micro-filtration using a micro-filtration membrane, and then packaged to obtain a target sample.

The compounds used in the following examples can be obtained via well-known synthesis processes or via commercial purchase, and was confirmed via measurements to ensure that these compounds met the standards for electronic compounds.

For simple and clear representation, the groups contained in the compounds in the following examples are represented using the codes shown in Table 1.

TABLE 1

| Code | Group | Code | Group | Code | Group |
|---|---|---|---|---|---|
| A | 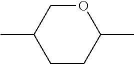 | G | —C₂H₄— | P | 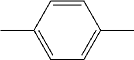 |
| B | 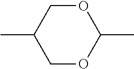 | H | H | Q | —CF₂O— |
| C | 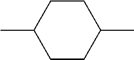 | I | —CH₂O— | T | ≡ |
| D | ═ | M | 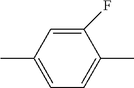 | O5FA | —OCF₂CF═CF₂ |
| E | —COO— | N | 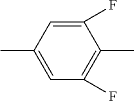 | OTF | —OCF₃ |
| F | F | O | O | Y | 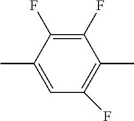 |

For example, the chemical structures of some compounds and the groups contained therein are illustrated in Table 2 below.

TABLE 2

| | |
|---|---|
| 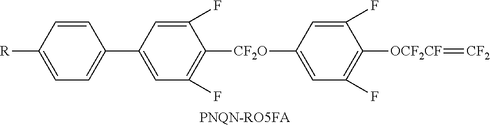 | 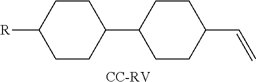 |
| 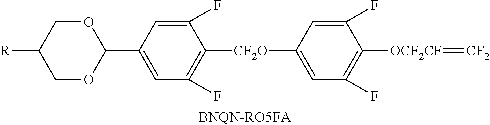 | 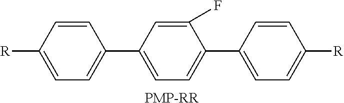 |
| 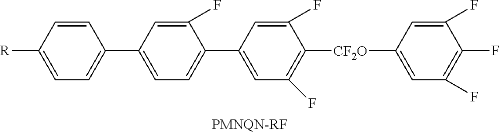 | 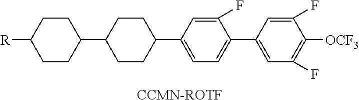 |
| 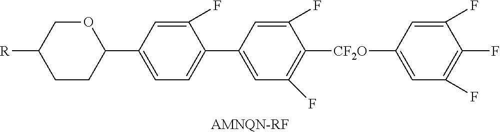 | 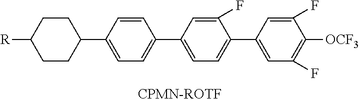 |

The codes, the categories, and the amounts of the compounds in Example 1, and the properties of a liquid crystal composition prepared from the compounds are summarized in Table 3 below.

TABLE 3

| Code | Category | Amount (wt %) | Properties |
|---|---|---|---|
| CC-2D3 | Formula III | 36 | S-N (° C.): ≤−40 |
| CC-3D23 | Formula III | 8 | Cp (° C.): 75 |
| CCP-2D1 | Formula IV | 13 | Δ n: 0.103 |
| CCN-3F | Formula IV | 8 | Δ ε: 8.2 |
| CCM-2DF | Formula IV | 10 | γ1 (mPa · s): 63 |
| PMP-2F | Formula IV | 5 | |
| BYQN-3F | Formula I | 4 | |
| BYQN-5O5FA | Formula I | 6 | |
| PMNQN-3F | Formula II | 5 | |
| AMNQN-3F | Formula II | 5 | |

The codes, the categories, and the amounts of the compounds in Example 2, and the properties of a liquid crystal composition prepared from the compounds are summarized in Table 4 below.

TABLE 4

| Code | Category | Amount (wt %) | Properties |
|---|---|---|---|
| CC-2D3 | Formula III | 43 | S-N (° C.): ≤−40 |
| CC-3D23 | Formula III | 6 | Cp (° C.): 76 |
| PP-41D1 | Formula IV | 5 | Δ n: 0.111 |
| CPP-32 | Formula IV | 3 | Δ ε: 4.5 |
| PMP-32 | Formula IV | 4 | γ1 (mPa · s): 45 |
| PMP-33 | Formula IV | 4 | |
| PMP-2F | Formula IV | 9 | |
| PMP-3F | Formula IV | 3 | |
| CPN-3F | Formula IV | 4 | |
| PYQN-3O5FA | Formula I | 8 | |
| APYQN-3F | Formula I | 6 | |
| PMNQN-3F | Formula II | 3 | |
| PMNQN-4F | Formula II | 2 | |

The codes, the categories, and the amounts of the compounds in Example 3, and the properties of a liquid crystal composition prepared from the compounds are summarized in Table 5 below.

TABLE 5

| Code | Category | Amount (wt %) | Properties |
|---|---|---|---|
| CC-2D3 | Formula III | 35 | S-N (° C.): ≤−40 |
| CC-3D23 | Formula III | 7 | Cp (° C.): 100 |
| CCP-3O1 | Formula IV | 4 | Δ n: 0.110 |
| CCP-2D1 | Formula IV | 10 | Δ ε: 4.3 |
| CCP-41D1 | Formula IV | 10 | γ1 (mPa · s): 60 |
| CPP-32 | Formula IV | 5 | |
| CMPC-33 | Formula IV | 1.5 | |
| PMP-2F | Formula IV | 3.5 | |
| PMP-3F | Formula IV | 4 | |
| CMN-5F | Formula IV | 6 | |
| CYQN-3O5FA | Formula I | 4 | |
| BPYQN-4F | Formula I | 5 | |
| PMNQN-3F | Formula II | 5 | |

The codes, the categories, and the amounts of the compounds in Example 4, and the properties of a liquid crystal composition prepared from the compounds are summarized in Table 6 below.

TABLE 6

| Code | Category | Amount (wt %) | Properties |
|---|---|---|---|
| CC-2D3 | Formula III | 50 | S-N (° C.): ≤−40 |
| CCP-2D3 | Formula IV | 5 | Cp (° C.): 90 |
| CPP-32 | Formula IV | 4 | Δ n: 0.116 |
| PMP-2F | Formula IV | 3 | Δ ε: 6.6 |
| PMP-3F | Formula IV | 3 | γ1 (mPa · s): 67 |
| CPTP-32 | Formula IV | 5 | |
| CCPN-3F | Formula IV | 4 | |
| CCPN-5F | Formula IV | 3 | |
| PYQN-3F | Formula I | 3 | |
| AYQN-5F | Formula I | 4 | |
| APYQN-3F | Formula I | 5 | |
| PMNQN-3F | Formula II | 5 | |
| PMNQN-4F | Formula II | 6 | |

The codes, the categories, and the amounts of the compounds in Example 5, and the properties of a liquid crystal composition prepared from the compounds are summarized in Table 7 below.

TABLE 7

| Code | Category | Amount (wt %) | Properties |
|---|---|---|---|
| CC-2D3 | Formula III | 42 | S-N (° C.): ≤−40 |
| CC-3D23 | Formula III | 12 | Cp (° C.): 80 |
| PP-41D1 | Formula IV | 6 | Δ n: 0.098 |
| CCP-2D1 | Formula IV | 10 | Δ ε: 2.4 |
| CCP-41D1 | Formula IV | 6 | γ1 (mPa · s): 45 |
| CPP-32 | Formula IV | 3 | |
| PMP-32 | Formula IV | 7 | |
| PYQN-3F | Formula I | 8 | |
| PMNQN-3F | Formula II | 3 | |
| PMNQN-4F | Formula II | 3 | |

The codes, the categories, and the amounts of the compounds in Example 6, and the properties of a liquid crystal composition prepared from the compounds are summarized in Table 8 below.

TABLE 8

| Code | Category | Amount (wt %) | Properties |
|---|---|---|---|
| CCP-2D3 | Formula III | 20 | S-N (° C.): ≤−40 |
| CCP-2D1 | Formula IV | 6 | Cp (° C.): 100 |
| CCP-41D1 | Formula IV | 14 | Δ n: 0.086 |
| CCN-3F | Formula IV | 14 | Δ ε: 9.0 |
| CCN-4F | Formula IV | 10 | γ1 (mPa · s): 101 |
| CCN-5F | Formula IV | 10 | |
| PMN-5F | Formula IV | 5 | |
| AYQN-3O5FA | Formula I | 5 | |
| BYQN-3F | Formula I | 5 | |
| PYQN-3O5FA | Formula I | 5 | |
| PMNQN-3F | Formula II | 3 | |
| PMNQN-4F | Formula II | 3 | |

The codes, the categories, and the amounts of the compounds in Example 7, and the properties of a liquid crystal composition prepared from the compounds are summarized in Table 9 below.

TABLE 9

| Code | Category | Amount (wt %) | Properties |
|---|---|---|---|
| CC-2D3 | Formula III | 33 | S-N (° C.): ≤−40 |
| CC-3D23 | Formula III | 9 | Cp (° C.): 92 |
| PP-41D1 | Formula IV | 2 | Δ n: 0.096 |
| CCP-2D1 | Formula IV | 10 | Δ ε: 4.8 |
| CCP-41D1 | Formula IV | 10 | γ1 (mPa · s): 60 |
| CCP-32 | Formula IV | 6 | |
| PMP-2F | Formula IV | 3 | |
| PMP-3F | Formula IV | 3 | |
| CCP-3OTF | Formula IV | 7 | |
| CCPM-3F | Formula IV | 2 | |
| BYQN-3O5FA | Formula I | 4 | |
| PYQN-3F | Formula I | 5 | |
| PMNQN-3F | Formula II | 6 | |

The codes, the categories, and the amounts of the compounds in Example 8, and the properties of a liquid crystal composition prepared from the compounds are summarized in Table 10 below.

TABLE 10

| Code | Category | Amount (wt %) | Properties |
|---|---|---|---|
| CC-2D3 | Formula III | 34 | S-N (° C.): ≤−40 |
| CC-3D23 | Formula III | 8 | Cp (° C.): 96 |
| PP-41D1 | Formula IV | 2 | Δ n: 0.097 |
| CCP-2D1 | Formula IV | 10 | Δ ε: 5.0 |
| CCP-41D1 | Formula IV | 10 | γ1 (mPa · s): 65 |
| CCP-32 | Formula IV | 4 | |
| PMP-3F | Formula IV | 4 | |
| CCP-3OTF | Formula IV | 7 | |
| CCPM-5F | Formula IV | 2 | |
| PYQN-3F | Formula I | 4 | |
| PYQN-5O5FA | Formula I | 4 | |
| BPYQN-5F | Formula I | 2 | |
| PMNQN-3F | Formula II | 4 | |
| AMNQN-3F | Formula II | 5 | |

The codes, the categories, and the amounts of the compounds in Example 9, and the properties of a liquid crystal composition prepared from the compounds are summarized in Table 11 below.

TABLE 11

| Code | Category | Amount (wt %) | Properties |
|---|---|---|---|
| CC-2D3 | Formula III | 32 | S-N (° C.): ≤−40 |
| CC-3D23 | Formula III | 4 | Cp (° C.): 82 |
| PP-41D1 | Formula IV | 4 | Δ n: 0.107 |
| CCP-2D1 | Formula IV | 10 | Δ ε: 7.5 |
| CCP-41D1 | Formula IV | 10 | γ1 (mPa · s): 63 |
| PMP-2F | Formula IV | 3 | |
| PMP-3F | Formula IV | 3 | |
| CCP-3OTF | Formula IV | 7 | |
| BYQN-3F | Formula I | 5 | |
| PYQN-3F | Formula I | 4 | |
| PYQN-5O5FA | Formula I | 4 | |
| APYQN-3F | Formula I | 7 | |
| PMNQN-5F | Formula II | 7 | |

The codes, the categories, and the amounts of the compounds in Example 10, and the properties of a liquid crystal composition prepared from the compounds are summarized in Table 12 below.

TABLE 12

| | | Amount | |
|---|---|---|---|
| Code | Category | (wt %) | Properties |
| CC-2D3 | Formula III | 35 | S-N (° C.): ≤−40 |
| PP-41D1 | Formula IV | 5 | Cp (° C.): 87 |
| CCP-2D1 | Formula IV | 10 | Δ n: 0.098 |
| CCP-41D1 | Formula IV | 10 | Δ ε: 7.5 |
| PMP-2F | Formula IV | 3 | γ1 (mPa · s): 65 |
| PMP-3F | Formula IV | 3 | |
| CCP-3OTF | Formula IV | 6 | |
| CCMN-3OTF | Formula IV | 3 | |
| PYQN-3F | Formula I | 5 | |
| PYQN-5F | Formula I | 5 | |
| APYQN-3F | Formula I | 5 | |
| PMNQN-4F | Formula II | 5 | |
| APNQN-3F | Formula II | 5 | |

As shown in Examples 1 to 10 above, by introducing functional groups to modify the molecular structures of some of the compounds, the dielectric anisotropy in a direction transverse to a molecular axis is increased and the light transmittance in the IPS-TFT and FFS-TFT mode LCDs is enhanced. Specifically, two hydrogen atoms at two ortho positions of a phenylene group relative to —CF₂O— in each of Formulae (I) and (II) are substituted with two fluorine atoms. Since it is not necessary to further add liquid crystal having negative dielectric anisotropy into the liquid crystal composition of the disclosure, the ultraviolet stability of the liquid crystal composition of the disclosure is not undesirably reduced. Furthermore, the liquid crystal composition of the disclosure is prepared via specific combination of at least one polar compound of Formula (I), at least one polar compound of Formula (II), at least one compound of Formula (III), and at least one compound of Formula (IV). Since the liquid crystal composition of the disclosure is confirmed to have high clear point, proper birefringence anisotropy, high dielectric anisotropy, low rotational viscosity, and fast response speed, the liquid crystal composition of the disclosure can be applied for active matrix LCDs with a high contrast ratio, such as IPS-TFT and FFS-TFT mode LCDs.

In the description above, for the purposes of explanation, numerous specific details have been set forth in order to provide a thorough understanding of the embodiment (s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A liquid crystal composition, comprising:
at least one polar compound represented by Formula (I), 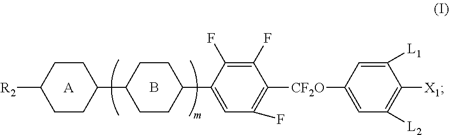
at least one polar compound represented by Formula (II), 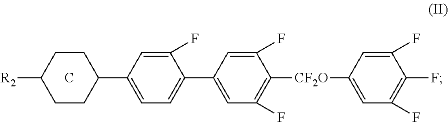
at least one compound represented by Formula (III), 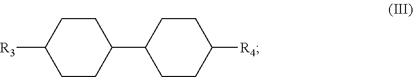
and
at least one compound represented by Formula (IV), 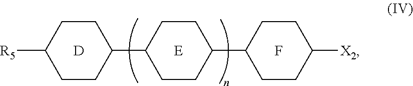
wherein
R₁, R₂, R₃, R₄, and R₅ are each independently selected from the group consisting of hydrogen, an alkyl group having 1 to 7 carbon atoms, an alkoxy group having 1 to 6 carbon atoms, an alkenyl group having 2 to 7 carbon atoms, and an alkenoxy group having 3 to 5 carbon atoms, wherein each of said alkyl group, said alkoxy group, said alkenyl group, and said alkenoxy group is unsubstituted or substituted with fluorine; 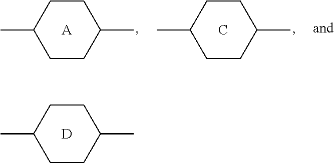
each independently represent a member selected from the group consisting 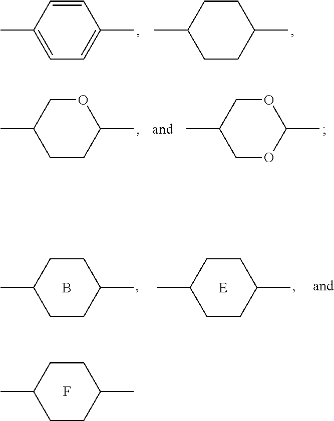
each independently represent at least one member selected from the group consisting of 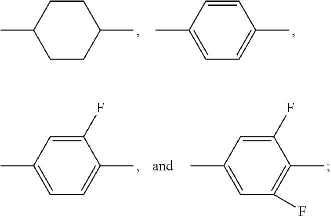
L₁ and L₂ are each independently selected from the group consisting of hydrogen and fluorine;
X₁ and X₂ are each independently selected from the group consisting of fluorine, chlorine, an alkyl group having 1 to 6 carbon atoms, a haloalkyl group having 1 to 6 carbon atoms, an alkenyl group having 2 to 6 carbon atoms, a haloalkenyl group having 2 to 6 carbon atoms, a haloalkoxy group having 1 to 6 carbon atoms, and a haloalkenoxy group having 2 to 6 carbon atoms;
m represents 0 or 1; and
n represents 0, 1, or 2,
with the proviso that when m represents 2, two of 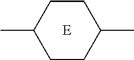
may be the same or different, and when n represents 0, 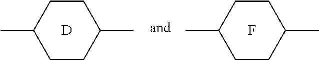
are not 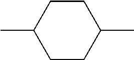
at the same time.

2. The liquid crystal composition according to claim 1, wherein said polar compound represented by Formula (I) is selected from the group consisting of compounds of Formulae (I-1) to (I-13),

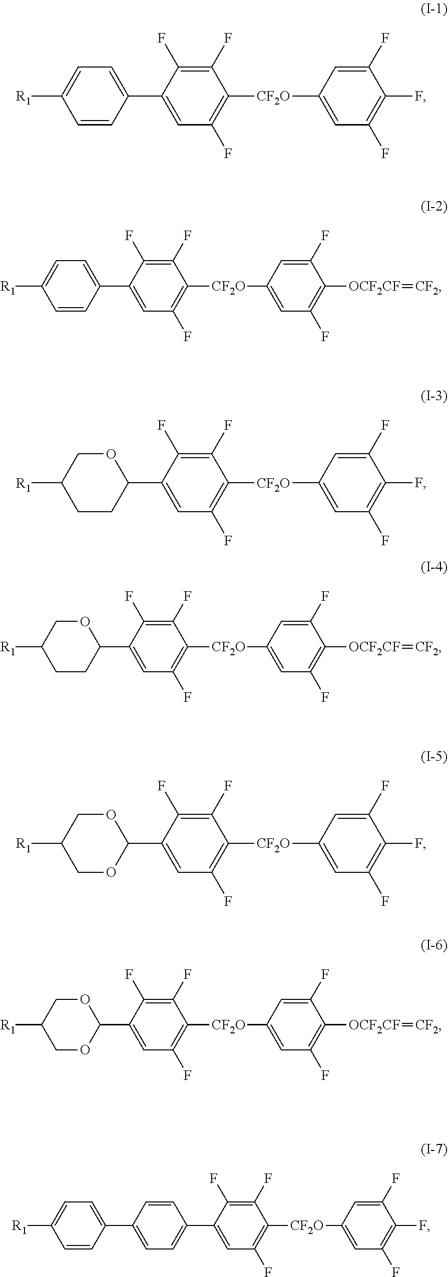

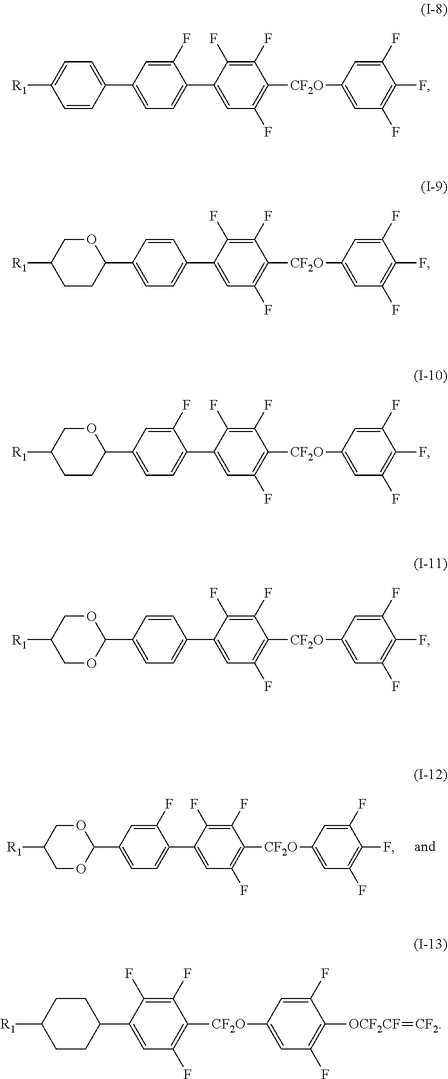

3. The liquid crystal composition according to claim 1, wherein said polar compound represented by Formula (II) is selected from the group consisting of compounds of Formulae (II-1) to (II-3),

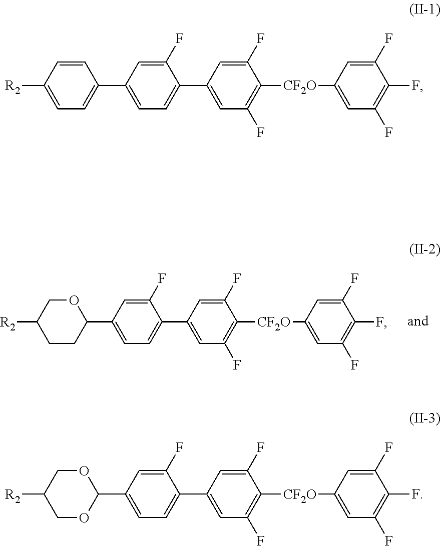

4. The liquid crystal composition according to claim 1, wherein said compound represented by Formula (III) is selected from the group consisting of compounds of Formulae (III-1) and (III-2),

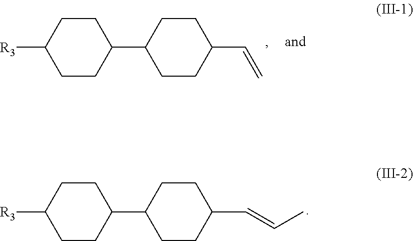

5. The liquid crystal composition according to claim 1, wherein said compound represented by Formula (IV) is selected from the group consisting of compounds of Formulae (IV-1) to (IV-21),

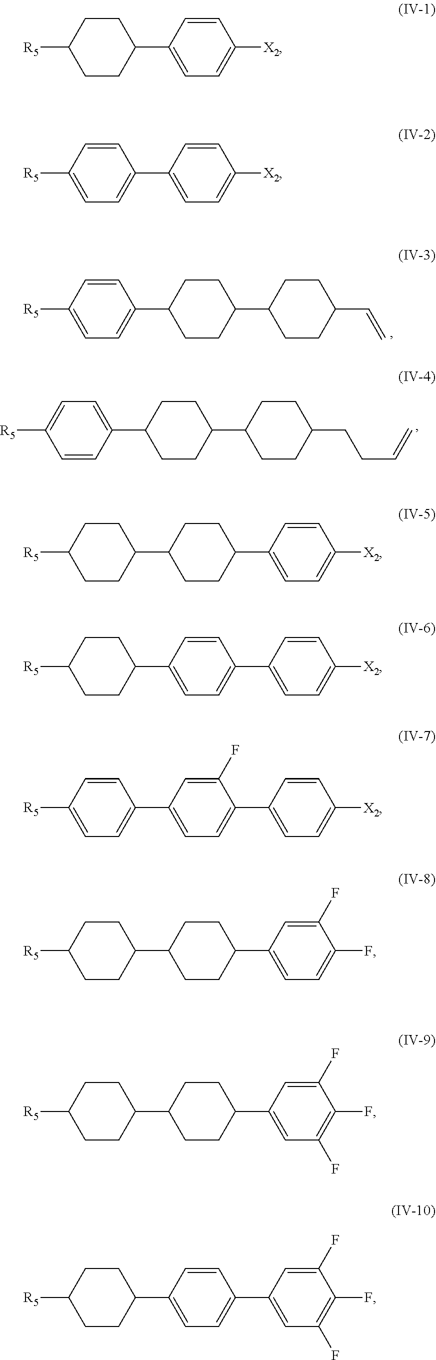

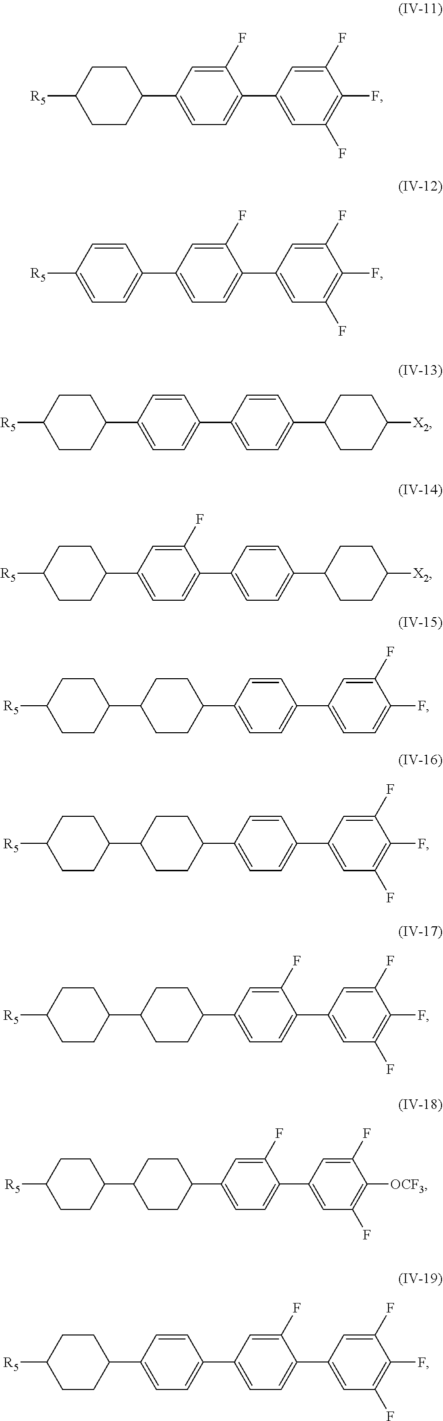

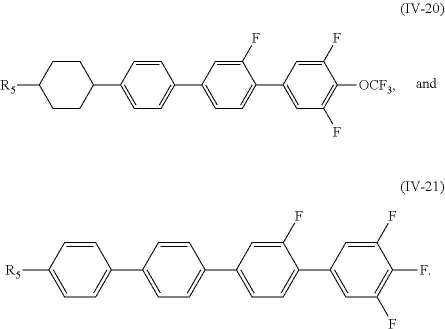

6. The liquid crystal composition according to claim 1, wherein said polar compound represented by Formula (I) is in an amount ranging from 1 wt % to 20 wt %, said polar compound represented by Formula (II) is in an amount ranging from 1 wt % to 30 wt %, said compound represented by Formula (III) is in an amount ranging from 1 wt % to 70 wt %, and said compound represented by Formula (IV) is in an amount ranging from 1 wt % to 60 wt % based on 100 wt % of said liquid crystal composition.

7. A liquid crystal display comprising the liquid crystal composition according to claim 1.
